(19) United States
(12) Patent Application Publication
(10) Pub. No.: US 2006/0007093 A1
(43) Pub. Date: Jan. 12, 2006

(54) Liquid crystal display apparatus and a driving method thereof

(76) Inventor: Kwang-Hyun La, Kyungki-do (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 10/512,509

(22) PCT Filed: Jul. 22, 2002
(86) PCT No.: PCT/KR02/01373

§ 371 Date: Jul. 26, 2005

(30) Foreign Application Priority Data
May 27, 2002 (KR) 2002/29226

(51) Int. Cl. G09G 3/36

(52) U.S. Cl. 345/96

(57) ABSTRACT

The present invention relates to a liquid crystal display with two or more line inversion. The timing controller of the liquid crystal display controls polarity of the image data to be reversed every two or more rows, combines the image data for the pixels with the polarity inversion and compensation data for excessive charging of the pixels by a predetermined level, and outputs the combined data. For this purpose, the timing controller includes a vector table for storing the number of frames and lines to be compensated for a frequency of a clock signal, a frame frequency, and a line frequency. In order to apply voltages for excessive charging of the pixel with polarity inversion, the compensation data stored in the vector table is combined with the image data from the external graphics source, and the liquid crystal panel is driven using the combined data. The compensation data are determined in advance in consideration of the brightness difference at the difference locations on the display panel and the frame charge level compensation for frames.

### BACKGROUND OF THE INVENTION

(a) Field of the Invention

The present invention relates to a liquid crystal display, and in particular, to a liquid crystal display with two or more line inversion which reverses polarity of applied voltages every two or more rows for preventing the deterioration of LC. The present invention relates to an LCD for improving uniformity of image quality of pixels in the rows having reversed polarity.

(b) Description of the Related Art

Recently, displays used for personal computers or TVs are required to be light and slim, and flat panel displays such as liquid crystal display (LCD) instead of cathode ray tubes are developed and put to practical use for satisfying such a requirement.

The LCD includes a panel including a pixel matrix pattern and another panel opposite thereto. A liquid crystal (LC) having dielectric anisotropy is interposed between the panels. An electric field is generated between the panels. Desired images are displayed by adjusting the field strength to control the transmittance of light passing through the panels.

The LCD receives n-bit red, green, blue (RGB) data from an external graphics source. A timing controller of the LCD data-transforms the RGB data and a data driving integrated circuit (IC) selects gray voltages corresponding to the RGB data. The selected gray voltages are applied to the pixels of the panels to perform display. The gray voltages are DC components. Long-time application of DC gray voltages to the pixels on the panels deteriorates the LC in the pixels. This kind of the deterioration of the LC can be prevented by inversion which reverses the polarity every pixel, every pixel line (or row), or every frame. The present invention relates to an LCD in double-line inversion.

FIG. 1A illustrates a pixel pattern of a LC panel in double-line inversion, and FIG. 1B illustrates a voltage charging state of pixels in four sequential rows under the application of the double-line inversion.

As shown in FIG. 1A, the LC panel reverses the polarity of voltages applied to the pixels every two pixel rows. The symbol “+” indicates the positive polarity and the symbol “−” indicates the negative polarity. FIG. 1B illustrates a waveform of the voltage charged in four sequential pixels in an arbitrary odd pixel column in the LC panel.

The LCD in the double-line inversion has a problem that the pixels in the rows where the polarity of the applied voltages is reversed are not sufficiently charged. For instance, the voltages of the pixels in the first and the third rows shown in FIG. 1B are such a case. Referring to FIG. 1B, assuming that the same gray voltage is applied to the pixels in the first and the second rows, the amount of charged voltages in the pixels should be equal. However, since a predetermined transition time for the voltage of the pixels of the first row to reach a target level is consumed due to the polarity inversion, the charged voltages is not equal for the pixels in the first and the third rows. The difference in the charged voltage induces a difference in the brightness, thereby deteriorating the display quality. The charge difference is resulted from the radical variation in the applied voltages to the pixels due to the polarity inversion, the signal wire resistance, and the load characteristic of the LC panel.

Such a phenomenon is present in the three or more-lines inversion as well as in the double-line inversion although there is a variation in the degree thereof.

### SUMMARY OF THE INVENTION

It is a motivation of the present invention to provide an LCD and a driving method thereof capable of generating compensation data for applying excessive charging voltages to the pixels in the rows with the polarity inversion under the application of the inversion reversing the polarity of the applied voltages every two or more lines.

The liquid crystal display includes a liquid crystal panel having a plurality of gate lines and a plurality of data lines intersecting each other, and a plurality of pixels provided near the intersections of the gate lines and the data lines; a gate driver for sequentially scanning the gate lines of the liquid crystal panel with a gate-on voltage and a gate-off voltage; a data driver for selecting gray voltages corresponding to image data, and applying the selected gray voltages to the data lines of the liquid crystal panel; a voltage generator for generating and outputting the gate-on voltage and the gate-off voltage for the gate driver and the gray voltages for the data driver; and a timing controller for generating control signals required for the gate driver and the data driver, and converting data format of the input image data from an external graphics source suitable for the data driver, wherein the timing controller controls polarity of the image data to be reversed every two or more rows, combines the image data for the pixels with the polarity inversion and compensation data for excessive charging of the pixels by a predetermined level, and outputs the combined data.

The timing controller includes a vector table for storing the number of frames and lines to be compensated for a frequency of a clock signal, a frame frequency, and a line frequency as well as an address information and a data information with the data structure where the image data function as the address information and the compensation data corresponding to the image data as the data information.

In order to apply voltages for excessive charging of the pixel with polarity inversion, the compensation data stored in the vector table is combined with the image data from the external graphics source, and the liquid crystal panel is driven using the combined data. The compensation data are determined in advance in consideration of the brightness difference at the difference locations on the display panel and the frame charge level compensation for frames.

### BRIEF DESCRIPTION OF THE DRAWINGS

The advantages of the present invention will become more apparent by describing preferred embodiments thereof in detail with reference to the accompanying drawings in which:

FIG. 1A illustrates the polarity pattern for a LC panel in a conventional double-line inversion;

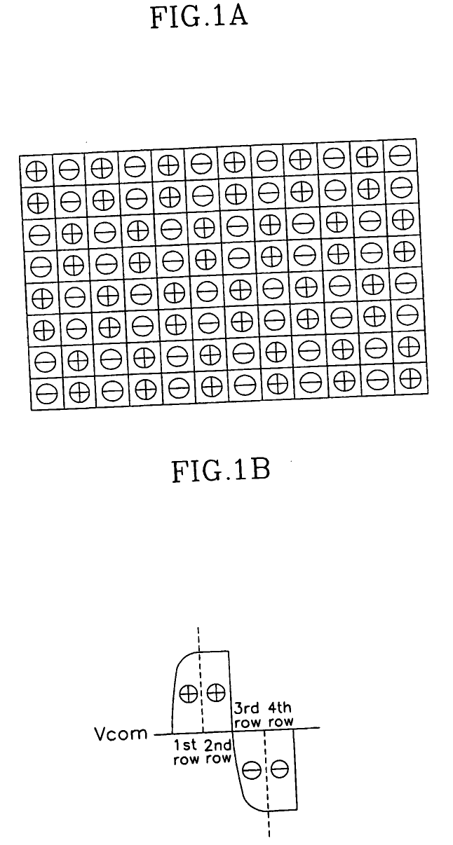

FIG. 1B illustrates the voltage charging state of the pixels of four sequential rows under the application of the double-line inversion;

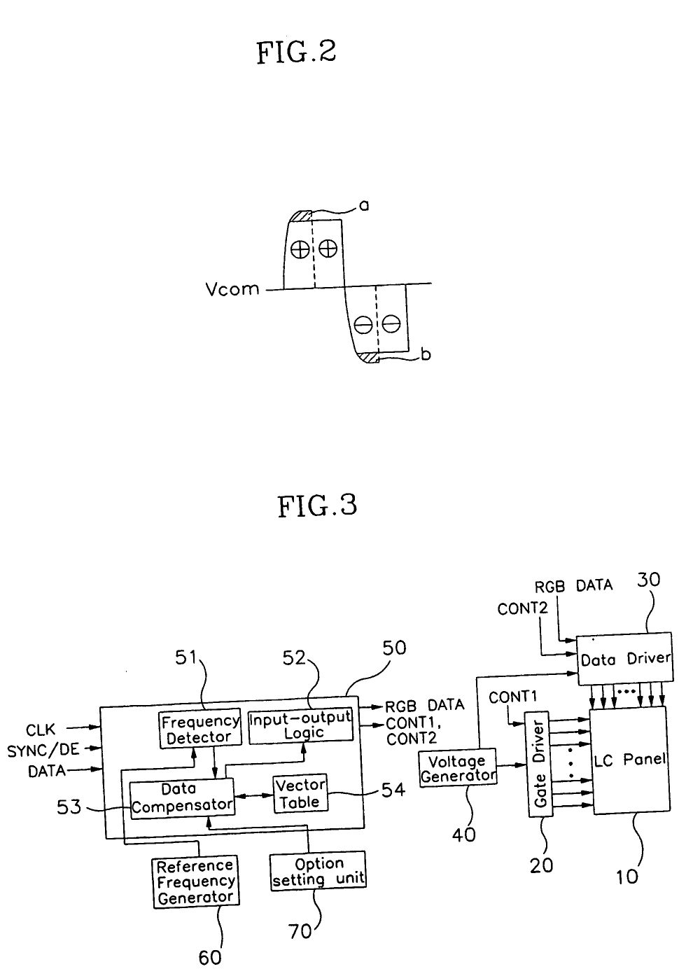

FIG. 2 illustrates the voltage charging state of the pixels for explaining a principle of the present invention;

FIG. 3 is a block diagram of an LCD according to the present invention;

FIGS. 4A and 4B illustrate compensation processes depending on a location of the LC panel and on the frames, respectively;

FIG. 5 is a flowchart illustrating a process of generating compensation data in an LCD according to an embodiment of the present invention; and

FIGS. 6 and 7 illustrate exemplary vector tables in an LCD according to an embodiment of the present invention.

(Description of the reference numerals for the major components of the drawings)

| | |
|---|---|
| 10: Liquid crystal panel, | 20: Gate driver |
| 30: Data driver, | 40: Voltage generator |
| 50: Timing controller, | 51: Frequency detector |
| 52: Input-output logic, | 53: Data compensator |
| 54: Vector table, | 60: Reference frequency generator |
| 70: Option setting unit | |

### DETAILED DESCRIPTION OF THE PREFERRED EMBODIMENTS

The present invention now will be described more fully hereinafter with reference to the accompanying drawings, in which preferred embodiments of the inventions are shown. The present invention may, however, be embodied in many different forms and should not be construed as limited to the embodiments set forth herein.

Now, LCDs and driving methods thereof according to embodiments of the present invention will be now described with reference to the accompanying drawings.

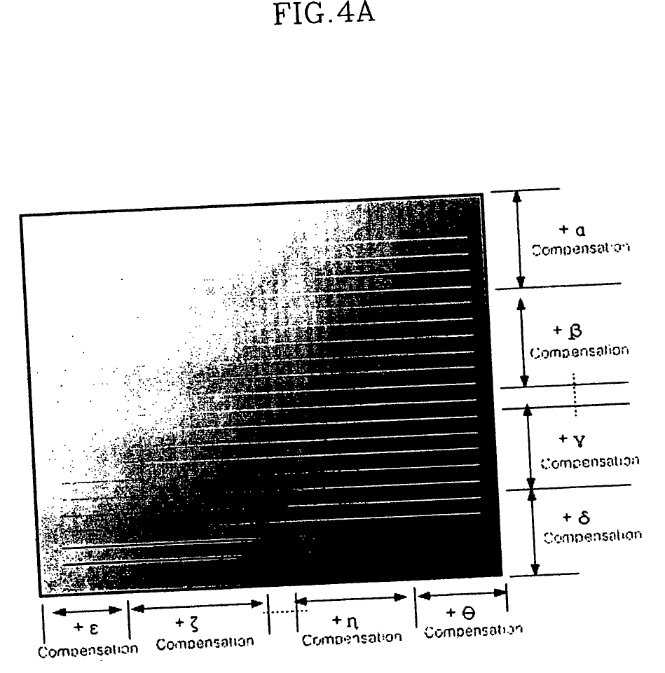

FIG. 2 illustrates a waveform of a voltage charged in pixels of four sequential rows in a LC panel in order to explain the principle of the present invention.

As shown in FIG. 2, the polarity is reversed at the pixels of the first and the third rows. Voltages with excessive charging levels are applied to the pixels with polarity inversion as indicated by the hatched portions (a) and (b). The excessive charging level refers to a predetermined compensation voltage level made by adding a predetermined voltage to a target voltage level. For instance, the excessive charging level (a) applied to the pixels having the polarity changing from (−) to (+) is slightly higher than a target gray voltage while the excessive charging level (b) applied to the pixels having the polarity changing from (+) to (−) is lower than the target gray voltage. The compensation voltage is obtained through adding a compensation data to RGB data fed from an external graphics source. Since the minimum unit of the compensation data is one bit, the pixel application voltage having the excessive charging level is eventually different from the target voltage by at least one gray. Accordingly, the degree of the excessive charging is too severe to cause the brightness difference due to the excessive charging. Therefore, the present invention does not apply the compensation voltage to all the rows in a frame, but apply the compensation voltage to predetermined locations with apparent brightness difference or apply the compensation voltage once during a predetermined number of frames, i.e., intermittently apply the compensation voltage such that the temporal average thereof yields minute compensation. Furthermore, since the charging difference may be also resulted from the frame refresh ratio or from the difference in the driving frequency, the application of the compensation voltage is also determined in consideration of the frequency conditions.

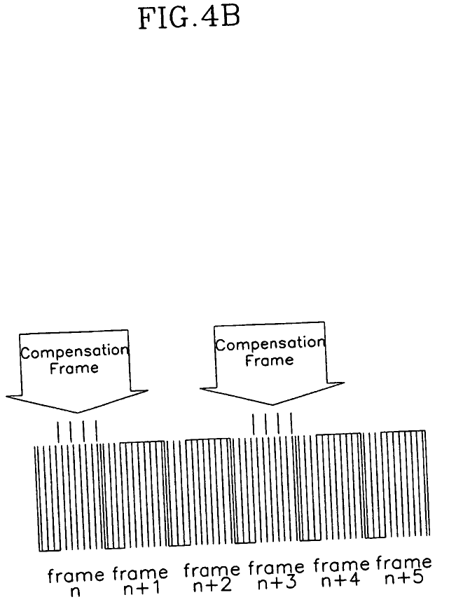

FIG. 3 is a block diagram of an LCD according to an embodiment of the present invention.

As shown in FIG. 3, an LCD according to an embodiment of the present invention includes a LC panel 10, a gate driver 20, a data driver 30, a voltage generator 40, a timing controller 50, a reference frequency generator 60, and an option setting unit 70.

The LC panel 10 includes a plurality of gate lines and a plurality of data lines intersecting each other, and a plurality of pixels provided near the intersections of the gate lines and the data lines. The gate driver 20 sequentially scans the gate lines on the LC panel 10 in response to control signals CONT2 from the timing controller 50. The data driver 30 applies gray voltages to the data lines on the LC panel 10 based on RGB data and control signals CONT1 from the timing controller 50. The gray voltages are determined by the RGB data and thus the light transmittance of the pixels for displaying a desired image on a screen. The voltage generator 40 generates voltages required for the gate driver 20 and the data driver 30. That is, the voltage generator 40 generates a gate-on voltage, a gate-off voltage, and a plurality of gray voltages having a predetermined level, and outputs them to the relevant drivers.

The timing controller 50 receives a clock signal CLK, synchronization signals SYNC, a data enable signal DE, and image data DATA from an external graphics source. The clock signal CLK refers to a clock signal functioning as a standard for circuit operation of the LCD. The synchronization signals SYNC refer to a vertical synchronization signal and a horizontal synchronization signal. The data enable signal DE is a reference signal for applying the gray voltages to the LC panel 10 from the data driver 30. The image signals DATA refer to the signals for displaying the images. The timing controller 50 generates the control signals CONT1 and CONT2 required for the gate driver 20 and the data driver 30 in synchronization with the clock signal CLK, the synchronization signals SYNC, and the data enable signal DE, and converts the data format of the image signals DATA suitable for the data driver 30. Furthermore, the timing controller 50 generates compensation data in accordance with the frequency of the clock signal CLK, the locations on the screen of the LC panel 10, the predetermined distance between frames or the option setting conditions, and generates compensated RGB data by combining the compensation data with the image signals DATA. As described earlier, there is a problem that the pixels with the polarity inversion are not sufficiently charged when the polarity of the gray voltages is reversed every two or more row. The embodiment of the present invention stores beforehand the compensation data in a table as function of the frequency of the clock signal CLK, the locations on the screen, the predetermined distance between frames or the option setting conditions, selects the compensation data suitable for given conditions, and reflects the selected compensation data on the RGB data. The compensation data represent the gray scale higher than the gray scale represented by the initial RGB data by one gray. The compensation data are not applied to all the pixels on the display screen, but to the pixels at the specific locations on the display screen with severe display distortion. Furthermore, the compensation data are not applied for all the frames, but intermittently applied once in a predetermined number of frames. In this way, the display distortion due to the compensated data is prevented since the temporally-averaged screen is perceived by human eyes. The options are determined by the option setting unit 70. The option setting unit 70 is configured such that the user can set the information about the frame frequency and the line frequency depending upon the kinds of the LCDs.

More specifically, the timing controller 50 includes a frequency detector 51, an input-output logic 52, a data compensator 53, and a vector table 54.

The frequency detector 51 for detecting the frequency of the clock signal CLK compares the frequency of the clock signal CLK with the reference frequency from the reference frequency generator 60 to detect the frequency of the clock signal CLK.

The vector table 54 can be implemented into a nonvolatile RAM or a ROM and stores compensation frames and compensation lines for the clock frequency, the line frequency and the frame frequency as well as address information for the image signals DATA and data information for the address information, which correspond the compensation data for the image signals DATA.

The data compensator 53 receives the frequency of the clock signal CLK from the frequency detector 51, and the frame frequency and the line frequency from the option setting unit 70. The data compensator 53 determines the compensation frame and the compensation line corresponding to the frequency information in the vector table and the compensation data corresponding to the input data signals DATA, and provides them for the input-output logic 52.

The input-output logic 52 combines the compensation data from the data compensator 53 with the data signals DATA from the external graphics source to thereby generate RGB data. In addition, the input-output controller 52 converts the data format of the RGB data and generates the control signals CONT1 and CONT2.

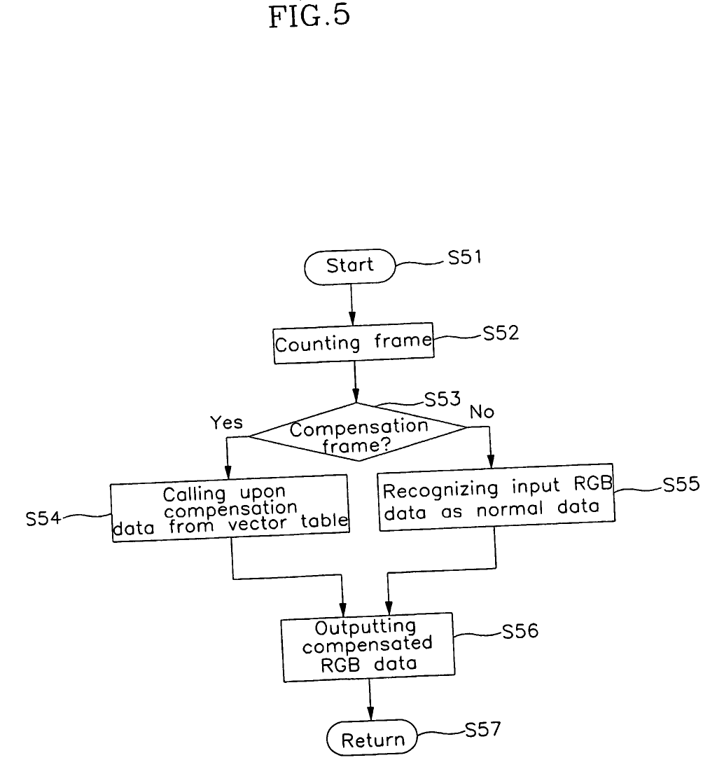

FIGS. 4A and 4B illustrate exemplary compensation processes for the locations on a LC panel and for the frames, respectively.

Referring to FIG. 4A, the luminance is different at the upper and lower locations and at the left and right locations of the LC panel. The embodiment of the present invention configures the vector table 54 such that the compensation data to be applied to the pixels depends on the locations of the pixels on the screen in order to remove the local brightness difference. That is, the values to be compensated at the locations on the display screen are determined in advance by actual measurements, and those values are translated into the compensation data, which in turn are applied to the vector table 54.

As shown in FIG. 4B, a compensation frame is selected for a predetermined number of frames. When the compensation data are applied to all frames, the displayed image is deviated from the target image. Therefore, the present invention determines the compensation frame among the predetermined number of frames. The number of the compensation frames and the number of the compensation lines to be supplied with the compensation data are experimentally determined depending upon the frequency of the clock signal CLK, the frame frequency, and the line frequency. The number of the compensation lines refers to the number of lines for receiving the compensation data within the compensation frame. Such information forms the vector table 54 in advance.

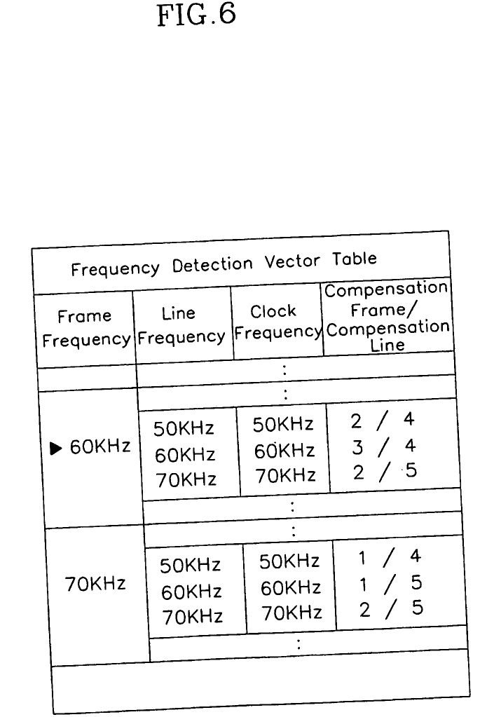

A process of generating compensation data by the timing controller 50 will be now described with reference to a flowchart shown in FIG. 5.

Upon start of the operation of the data compensator 53 (S51), the timing controller 50 counts the number of the frames using the input synchronization signal SYNC (S52). The timing controller 50 then determines whether the data signals DATA (which are distinguished by frames) currently input thereinto are related to a compensation frame (S53). This step is made such that the data compensator 53 searches the vector table 54, determines the compensation frames and the compensation lines corresponding to the clock frequency, the frame frequency, and the line frequency, and determines whether the current frame belongs to such compensation frames. When the current frame is determined to be the compensation frame in the step S53, the compensation data previously stored in the vector table 54 are read out therefrom. At this time, the data information stored in the vector table 54 is addressed by using the current frame data as the address information. Meanwhile, when it is determined that the current frame is not the compensation frame in the step S53, the current RGB data are recognized as normal data (S55). The compensation data obtained in the step S54 or the initial frame data in the step S55 are output to the input-output logic 52 of the timing controller 50 as the RGB data having suffered the compensation process (S56). The input-output logic 52 combines the compensation data and the data signal DATA input into the timing controller 50. Finally, the control flow returns to repeatedly perform the steps S52 to S56 for all input data.

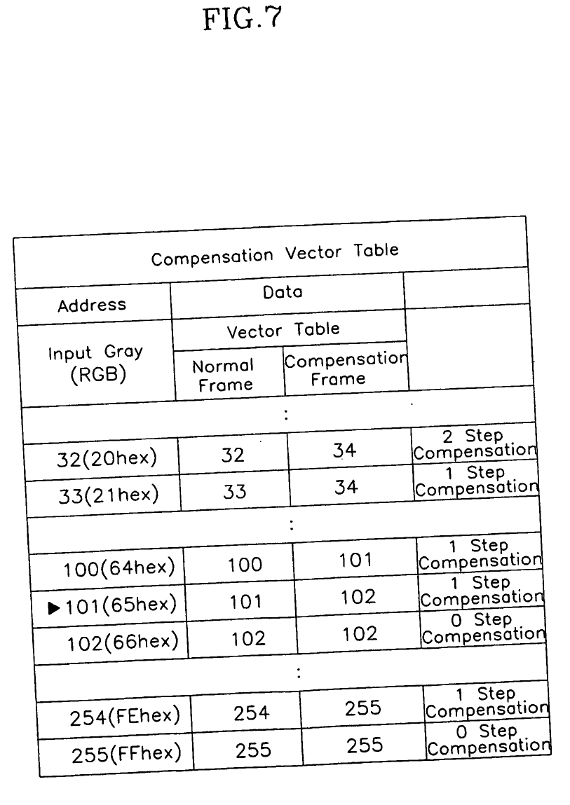

FIGS. 6 and 7 illustrate exemplary data stored in a vector table.

Two kinds of data are stored in the vector table.

First, as shown in FIG. 6, information about the number of the compensation frames and the number of the compensation lines for various kinds of frequencies is stored in the vector table. Second, as shown in FIG. 7, address information corresponding to input RGB data and data information corresponding to compensation data are stored in the vector table.

FIG. 6 illustrates the number of the compensation frames and the number of the compensation lines for various frame frequencies, various line frequencies, and various clock frequencies of the LCD. In case an LCD has a clock frequency of 60 MHz, a line frequency of 60 KHz, and a frame frequency of 60 Hz, the number of the compensation frames is three and the number of compensation lines is four. This means that the compensation is performed every three frames and every four lines.

As shown in FIG. 7, input RGB data in the hexadecimal system are assigned to an address item, and normal frame data and compensation frame data are assigned to the data item. For instance, when the gray (scale level) of the input RGB data is 101, the 101-th gray is output for a normal frame, and the 102-th gray is output for a compensation frame. As shown in FIG. 7, the present invention finely partitions the degree or the step of the compensation or optimizes the degree of the compensation for respective grays. That is, the steps of the compensation for the respective grays are optimally determined based on the experiments.

As described above, the LCD in two or more line inversion applies the excessive charging voltages to the pixels in the rows with the polarity lines using the compensation data. The compensation data are intermittently applied depending upon the brightness difference at the locations on the display screen and the driving frequency of the LCD. In this way, the non-uniformity in the image quality for the pixels in the row with the polarity inversion can be solved.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display in two or more line inversion, the liquid crystal display comprising:
a liquid crystal panel having a plurality of gate lines and a plurality of data lines intersecting each other, and a plurality of pixels provided near the intersections of the gate lines and the data lines;
a gate driver for sequentially scanning the gate lines of the liquid crystal panel with a gate-on voltage and a gate-off voltage;
a data driver for selecting gray voltages corresponding to image data, and applying the selected gray voltages to the data lines of the liquid crystal panel;
a voltage generator for generating and outputting the gate-on voltage and the gate-off voltage for the gate driver and the gray voltages for the data driver; and
a timing controller for generating control signals required for the gate driver and the data driver, and converting data format of the input image data from an external graphics source suitable for the data driver,
wherein the timing controller controls polarity of the image data to be reversed every two or more rows, combines the image data for the pixels with the polarity inversion and compensation data for excessive charging of the pixels by a predetermined level, and outputs the combined data.

2. The liquid crystal display of claim 1, further comprising:
a reference frequency generator supplying a reference frequency for detecting the frequency of a clock signal to the timing controller; and
an option setting unit for setting information about a frame frequency and a line frequency depending on the liquid crystal display and providing the information for the timing controller.

3. The liquid crystal display of claim 1 or 2, wherein the timing controller comprises:
a frequency detector for detecting a frequency of a clock signal required for driving the liquid crystal display;
a vector table storing the number of frames and the number of lines to be compensated for at least one driving frequency of the liquid crystal display, address information corresponding to the image data, and data information corresponding to the compensation data related to the image data;
a data compensator for reading out and output the compensation data stored in the vector table corresponding to image data from the external graphics source; and
an input-output logic for generating control signals required for driving the liquid crystal display, converting data format of the image data from the external graphics source, and combining the compensation data from the data compensator with the image data.

4. The liquid crystal display of claim 3, wherein the at least one driving frequency includes a frequency of a clock signal, a frame frequency, and a line frequency.

5. The liquid crystal display of claim 3, wherein the vector table comprises a non-volatile RAM or a ROM.

6. The liquid crystal display of claim 1, wherein the timing controller combines the compensation data for excessive charging and the image data of the pixels at predetermined locations on a display screen and output the combined data to the pixels.

7. The liquid crystal display of claim 1, wherein the timing controller outputs the compensation data corresponding to the image data input from the external graphics source for one of a predetermined number of frames.

8. A liquid crystal display two or more line inversion, the liquid crystal display comprising:
a liquid crystal panel having a plurality of gate lines and a plurality of data lines intersecting each other, and a plurality of pixels provided near the intersections of the gate lines and the data lines;
a gate driver for sequentially scanning the gate lines of the liquid crystal panel with a gate-on voltage and a gate-off voltage;
a data driver for selecting gray voltages corresponding to image data, and applying the selected gray voltages to the data lines of the liquid crystal panel;
a voltage generator for generating and outputting the gate-on voltage and the gate-off voltage for the gate driver and the gray voltages for the data driver; and
a timing controller for generating control signals required for the gate driver and the data driver, and converting data format of the input image data from an external graphics source suitable for the data driver,
wherein the timing controller controls the polarity of the image data to be reversed every two or more rows, and combines image data and compensation data for the image data such that the pixels with polarity changing from negative to positive are supplied with voltages having a level higher than initial gray voltages and the pixels with polarity changing from positive to negative are supplied with voltages having a level lower than initial gray voltages.

9. The liquid crystal display of claim 8, further comprising:
a reference frequency generator supplying a reference frequency for detecting the frequency of a clock signal to the timing controller; and
an option setting unit for setting information about a frame frequency and a line frequency depending on the liquid crystal display and providing the information for the timing controller.

10. The liquid crystal display of claim 8 or 9, wherein the timing controller comprises:
a frequency detector for detecting a frequency of a clock signal required for driving the liquid crystal display;
a vector table storing the number of frames and the number of lines to be compensated for at least one driving frequency of the liquid crystal display, address information corresponding to the image data, and data information corresponding to the compensation data related to the image data;
a data compensator for reading out and output the compensation data stored in the vector table corresponding to image data from the external graphics source; and
an input-output logic for generating control signals required for driving the liquid crystal display, converting data format of the image data from the external graphics source, and combining the compensation data from the data compensator with the image data.

11. A method of driving a liquid crystal display, the method comprising:
counting the number of frames for input RGB data using a synchronization signal;
determining whether a current frame is a compensation frame;
reading out compensation data previously stored in a vector table in case it is determined that the current frame is the compensation frame;
recognizing that the current frame is a normal frame in case it is determined that the current frame is not the compensation frame; and
combining the compensation data with the RGB data and outputting the compensation data obtained in the reading out and the normal frame data obtained in the recognition.

12. The method of claim 11, wherein the determination whether a current frame is a compensation frame is performed by determining the number of compensation frames and the number of compensation lines depending on a driving frequency by searching the vector table.
